(19) United States
(12) Patent Application Publication
(10) Pub. No.: US 2015/0369559 A1
(43) Pub. Date: Dec. 24, 2015

(54) Microcontroller System for Attachment to Weapon Holster

(71) Applicant: Tyler Patrick Del Rosario, Manassas, VA (US)

(72) Inventor: Tyler Patrick Del Rosario, Manassas, VA (US)

(21) Appl. No.: 14/307,505

(22) Filed: Jun. 18, 2014

(51) Int. Cl. F41C 27/00; G08C 19/12; H04N 5/765

(52) U.S. Cl. CPC F41C 27/00; H04N 5/765; G08C 19/12

(57) ABSTRACT

The electronic device attaches to the outside face of a personal weapon holster and comprises a microcontroller system and a single containing body that encloses said microcontroller system. Most notably, the microcontroller system of the electronic device comprises a Hall effect sensor, a permanent magnet, a microcontroller, a memory device, a radio transmitter, and a power supply. The said permanent magnet attaches to the backside of said Hall effect sensor, which faces toward the weapon receiving pocket of said weapon holster to determine the presence of a weapon with ferromagnetic properties through the magnitude of magnetic flux density detected from the proximity of said weapon. The said microcontroller interprets the signal from the said Hall effect sensor and outputs data to the said memory device and radio transmitter. The said memory device records contextual data pertaining to the insertion and withdrawal of a weapon from said weapon holster for later review. The said radio transmitter outputs radio signals to a video recording device located on the user of said weapon holster, independent of said electronic device, to start recording after the removal of a weapon from said weapon holster and to stop recording after the insertion of a weapon into said weapon holster.

### BACKGROUND OF THE INVENTION

The present invention pertains to the technical field of electronic devices. More particularly, the present invention pertains to the field of microcontroller systems for weapon holsters.

When an individual, particularly a law enforcement officer, withdraws a weapon from a holster for defensive or offensive reasons, a significant risk may be posed to the parties involved. The individual withdrawing the weapon and the individual(s) on the receiving side of the weapon face the risk of grave injury and civil or criminal consequences related to the circumstances and outcome of the encounter.

In response to these dangers, a few microcontroller based systems have been designed to supplement weapon holsters and provide a means to detect the removal of a weapon from such a weapon holster and then act through preventative or reactive methods to limit force misuse, force abuse, and collateral damage between parties.

An example of such a preventative measures is a weapon releasing mechanism controlled by a biometric sensor to prevent unauthorized weapon access. Examples of reactive measures include the sending of text messages, position data, audio, and images to a third party in a remote location to request emergency assistance when necessary, or the inclusion of an audio recording device to document incidents for auditing purposes.

Although the use of these aforementioned preventative and reactive measures hold potential to be affective in limiting force misuse, force abuse, and collateral damages, previous microcontroller systems do not satisfactorily meet at least one of the objectives needed for preferred implementation by individuals such as law enforcement officers. This is due to the type and/or placement of the weapon withdrawal detecting device and the overall placement of the microcontroller system with regards to the user, weapon, and weapon holster.

The objectives are as follows: The microcontroller system must not interfere with an authorized user's ability to withdrawal a weapon from their holster, handle said weapon, or access other attached equipment on their persons to enable said user to maintain effectiveness in their actions. The microcontroller system must be implemented without disturbance to either the weapon or weapon receiving pocket to enable users of said microcontroller system to avoid interference issues, as mentioned in the first objective, and to maintain full functionality. The microcontroller system must be easily implemented on a variety of holster designs to enable users of said microcontroller system to continue using their current weapon and weapon holster and to continue receiving the benefits of holster and weapon familiarity.

A brief summary of related previous inventions and their shortcomings are given below.

French et al., U.S. Pat. No. 6,641,009 discloses a holster with a built in computer system and a built in sensing device to detect the insertion or removal of a handgun from said holster. The design replaces rather than supplements holsters in present use. In other words, an individual would not be able to use his or her original weapon holster. In addition to a financial switching cost, users of prior holster designs may incur a decrease in handgun related performance due to unfamiliarity with wearing the disclosed holster and drawing a handgun from the disclosed holster.

Devine, U.S. Pat. No. 3,530,451 discloses an alarm system used in conjunction with a weapon holster that detects the removal of a weapon from said holster and in response, generates a radio signal to be received at a remote location. In one embodiment, the withdrawal of a weapon from the holster is detected through the use of a magnet attached to said weapon and an encapsulated reed switch within said holster, adjacent to said magnet when said weapon is within said holster. The system configuration requires a modification to the weapon surface and holster interior pocket. Such modifications may affect weapon weight and smoothness of weapon draw. Additionally, the radio would require large power consumption to transmit to a remote location.

Parish, U.S. Pat. No. 5,525,966 discloses a security system mounted with a weapon holster that detects the removal of a weapon from said weapon holster by means of a switch attached to the weapon retaining mechanism of said weapon holster. The security system also includes a transmitter to send a signal indicating removal of weapon from said weapon holster. Because a variety of different retaining mechanisms are used on weapon holsters, no one embodiment of the system for a specific retaining mechanism is guaranteed to work on a holster with another retaining mechanism. Additionally, the devices proximity to the retaining mechanism may interfere with the officer's ability to draw or withdraw their weapon. Lastly, a mechanical switch, such as the one disclosed, can fail to function due to dirt or rust.

Pike, U.S. Pat. No. 5,479,149 discloses a system worn by a law enforcement officer to detect the removal of a weapon from a weapon holster attached to said law enforcement officer, record all audible sounds adjacent to said law enforcement officer, and transmit the sounds and weapon removal data to a remote location. In the preferred embodiment, the sensor is attached within or behind the holster, and said sensor switches on and off an audio recording and transmitter device that is attached on to the belt of said law enforcement officer. The system requires multiple attachment points to function, however law enforcement officers may not have vacant belt space available or the additional belt attached device may interfere with the officer's ability to access adjacent items on their body. Additionally, the transmittal of data to a remote location requires large power consumption.

Hietanen, U.S. Pat. No. 7,714,720 discloses an alarm system comprising a detector connected to a holster to detect the removal of a use of force instrument from said holster, a CPU located within a device separate from said holster and detector, but still attached to the user of said holster, to receive signals from said detector, and a communication device attached to said user to automatically transmit said user's situational audio and information to a third party when a weapon is removed from said holster. The system requires multiple attachment points to function, however law enforcement officers may not have vacant space available or the additional attached device may interfere with the officer's ability to access adjacent items on their body.

### BRIEF SUMMARY OF THE INVENTION

To overcome the aforementioned problems with the previous inventions, the present invention, in a first aspect, is configured to be a small, single-body enclosed microcontroller system that attaches to the outside face of a personal weapon holster. This aspect enables said invention to be implemented on a variety weapon holsters, without reducing a user's ability to withdrawal a weapon from their holster, handle said weapon, or access other attached equipment on their persons when using said invention.

In a second aspect, the present invention includes a permanent magnet attached to the back face of a Hall effect sensor to detect the presence of a weapon in said weapon holster through a change in magnetic flux related to the proximity of a weapon to the front face of said Hall effect sensor. This aspect enables said invention to detect the presence of a weapon within a weapon holster without mechanical interaction with the weapon receiving pocket, holster retaining mechanism, or holster affiliated weapon.

### BRIEF DESCRIPTION OF THE SEVERAL VIEWS OF THE DRAWING

FIG. 1 is an isometric view of the present invention mounted on a weapon holster that contains a handgun;

FIG. 2 is a front view of the present invention mounted on a weapon holster that contains a handgun;

FIG. 3 is a front view of the containing body of the present invention, showing the microcontroller system;

FIG. 4 is a side view of the containing body of the present invention, showing the microcontroller system;

FIG. 5 is a front view of the present invention mounted on a weapon holster, showing the front face of the microcontroller system;

FIG. 6 is a side view of the present invention mounted on a weapon holster, showing the microcontroller system;

FIG. 7 is a front view of the present invention mounted on a weapon holster that contains a handgun, showing the microcontroller system and the handgun details, within said weapon holster;

FIG. 8 is a side, cut view of the present invention mounted on a weapon holster, showing the Hall effect device and the weapon slide;

FIG. 9 is a detailed view of FIG. 8, showing the Hall effect device and weapon slide;

FIG. 10 is a flow chart diagram showing the relationships between the electrical components of the present invention and of related to the present invention, during normal operation;

FIG. 11 is a flow chart diagram showing the relationships between the electrical components of the present invention and of related to the present invention, during the data retrieval process.

### DETAILED DESCRIPTION OF THE INVENTION

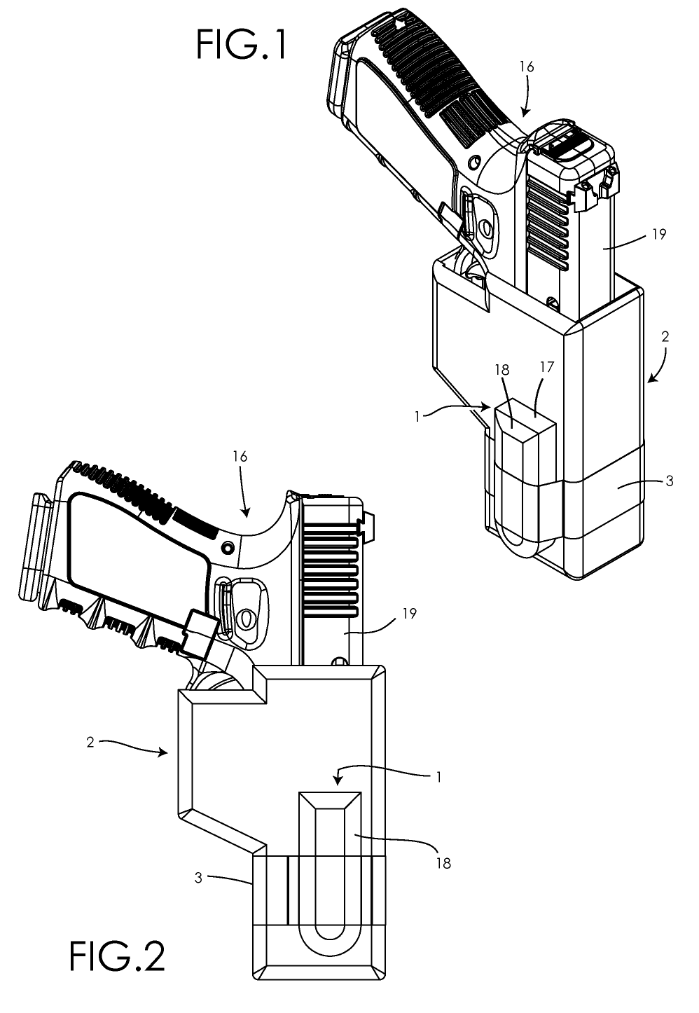

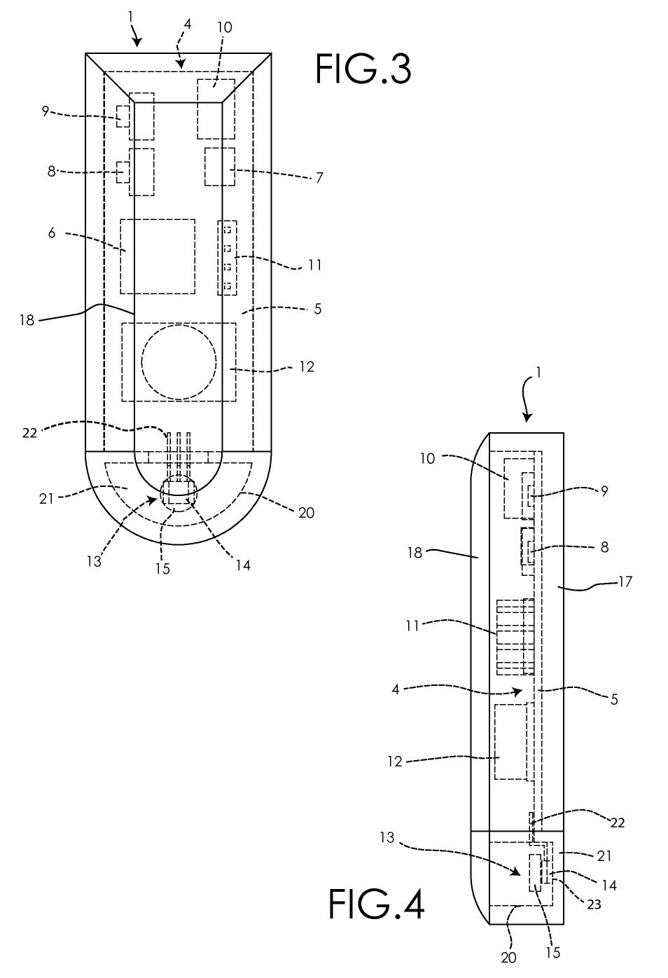

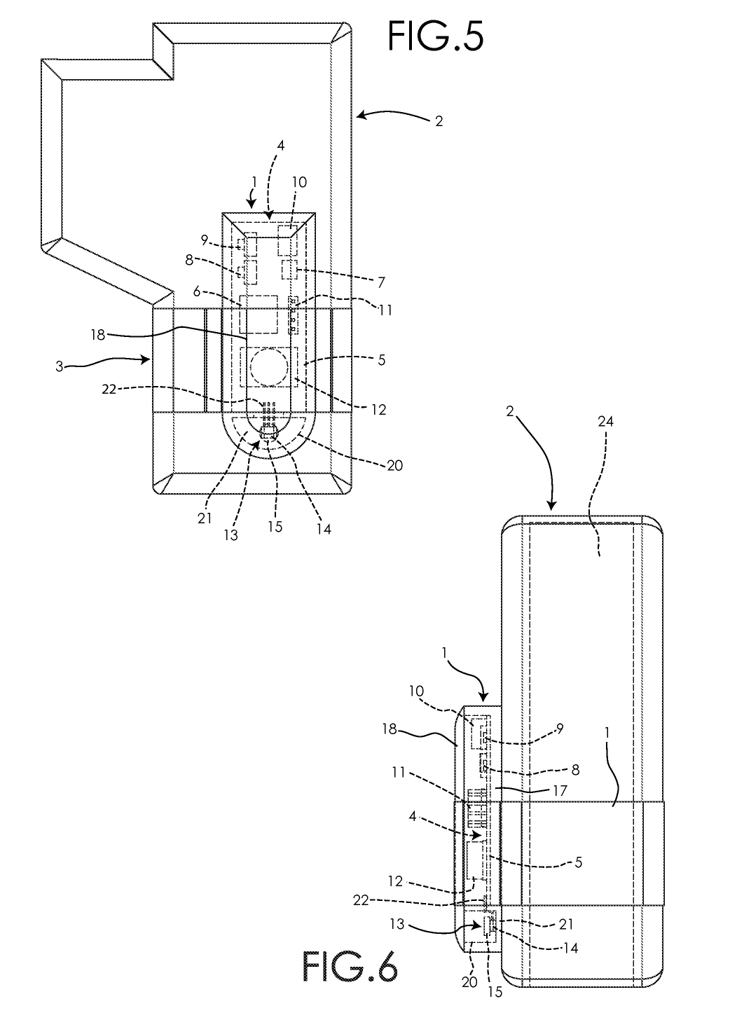

Referring now to the present invention in more detail, FIG. 1 and FIG. 2 show the preferred embodiment of a containing body 1 enclosing the microcontroller system 4 of the present invention attached to the outside face of a weapon holster 2 with a restraining device 3. As shown in FIG. 3, the microcontroller system 4 comprises a circuit board 5, a microcontroller 6, a memory device 7, a 3.3 volt regulator 8, a 5 volt regulator 9, a power supply 10, an adaptor 11, a radio transmitter 12, and a Hall effect device 13. As shown in FIG. 4, said Hall effect device 13 includes a Hall effect sensor 14 and a permanent magnet 15 to detect the presence of a weapon 16 with ferromagnetic properties within the weapon holster 2.

In the preferred embodiment, the weapon 16 is a pistol and the weapon holster 2 relates to the pistol. However, the weapon 16 may alternatively be an electroshock weapon, baton, or other personal weapon with ferromagnetic properties or associated with an item with ferromagnetic properties and the weapon holster 2 may be related to its aforementioned affiliated weapon 16.

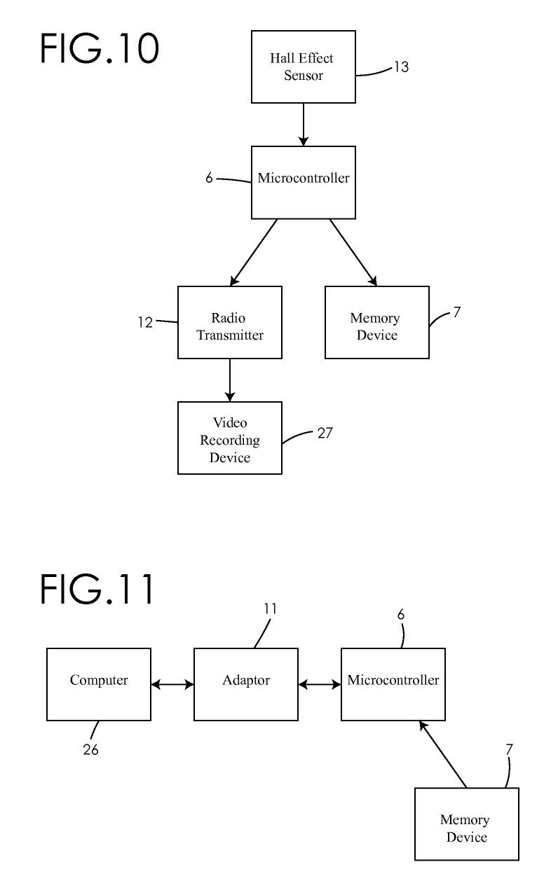

Referring to the electronic operations of the present invention as shown in FIG. 10, the Hall effect sensor 14 outputs a specific signal, based on the presence of a weapon 16 inside the weapon holster 2, to the microcontroller 6. The microcontroller 6 interprets said signal about the presence of a weapon 16 within the weapon holster 2 and outputs to the memory device 7 and the radio transmitter 12. The memory device 7 records data pertaining to the insertion and withdrawal of a weapon 16 from the weapon holster 2, such as the time and date of insertion or withdrawal. The radio transmitter 12 outputs radio signals to a video recording device 27 located on the user of the weapon holster 2, independent of said invention, to start and stop video recordings. In the preferred embodiment, the radio transmitter 12 sends a signal to the video recording device 27 to start recording after the removal of a weapon 16 from said weapon holster 2 and to stop recording after the insertion of a weapon 16 to said weapon holster 2. Additionally, the adaptor 11 enables recovery of the data from the memory device 7 to a computer 26 as shown in FIG. 11.

The Containing Body 1

In the preferred embodiment as shown in FIG. 3 and FIG. 4, the containing body 1 of the present invention comprises a lower body 17 and an upper body 18. The microcontroller system 4 is seated within the lower body 17 and the upper body 18 is secured onto the lower body 17 through the use of a device such as screws to enclose the microcontroller system 4. However, the containing body 1 may alternatively consist of any number of parts and any configuration to enclose the microcontroller system. As used herein, the phrase “containing body” means any number of parts that can be reasonably defined as a single entity exterior and at least partially surrounding to an item, or plurality of items, to restrict movement of said item(s) relative to its self. Additionally, while this description uses the term “enclose” to describe the containing body's 1 relationship with the microcontroller system 4, it will be understood that the containing body 1 may only partially surround the microcontroller system 4 as long as the microcontroller system 4 is restricted from movement, relative to the containing body 1, and is surrounded on all sides to an extent that effectively protects the microcontroller system 4 from harmful physical interaction, with at least one species of probable encountered foreign objects, when the containing body 1 is correctly associated with the weapon holster 2.

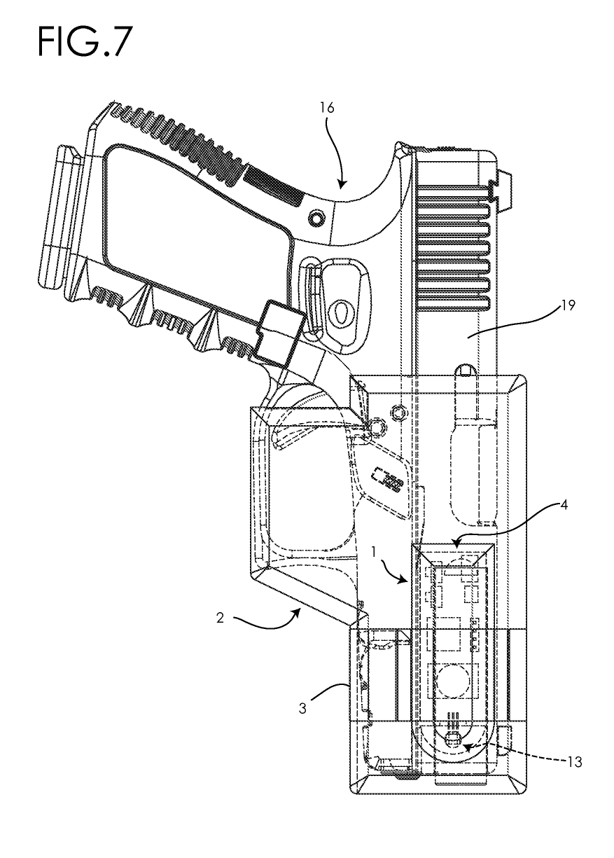

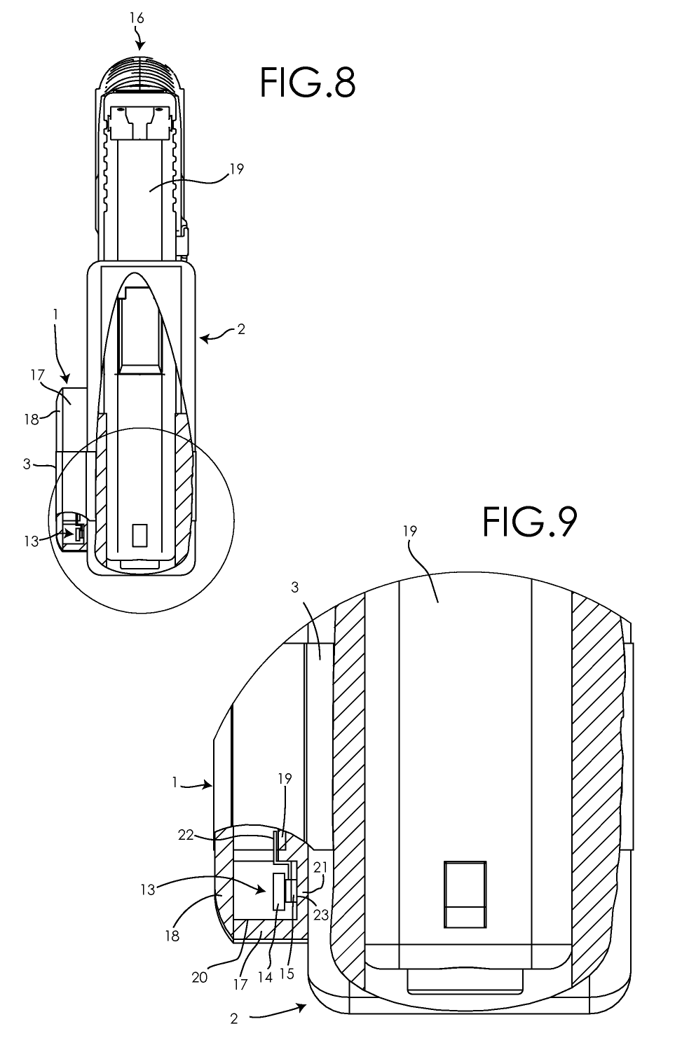

Referring to FIG. 7, FIG. 8 and FIG. 9, the containing body 1 is positioned so that the large exterior surface of the lower body 17 is flush to the exterior face of the weapon holster 2, and the microcontroller system's 4 Hall effect sensor 14 is pointed at a flat, ferromagnetic portion of the weapon 16, in this case the weapon's 16 upper receiver 19, while the weapon 16 is seated within the weapon holster 2. Additionally, the body 1 is positioned so that its longitudinal axis is parallel to that of the weapon holster 2.

The containing body 1 is attached to the weapon holster 2 through the use of a restraining device 3, which is preferably an adjustable belt or adhesive tape that wraps around the exterior of both the containing body 1 and the weapon holster 2, in the direction perpendicular to the longitudinal axis of both objects. Alternatively, the restraining device 3 may be located between the large exterior surface of the lower body 17 and the exterior face of the weapon holster 2 and have properties such as adhesion and/or hook and loop fastening on its faces to attach the containing body 1 to the weapon holster 2. The restraining device 3 is to hold the containing body 1 in the specified position on the weapon holster 2 until a person intends to remove the present invention from the weapon holster 2.

In further detail, the containing body 1 is of a minimal size to ensure minimal interference with a user's hand and body movements when withdrawing a weapon 16 from the weapon holster 2. The containing body 1 is to have an approximate normal stress distribution and minimal deformation for loads expected from typical use by having a certain thicknesses for both the lower body 17 and the upper body 18, and round edges for the upper body 18. The Hall effect device enclosure 20 portion of the lower body 16 has a sensor platform floor 21 that is of a thickness to minimize the distance between the Hall effect sensor 14 and a weapon 16 inside the weapon holster 2, to insure accurate Hall effect sensor 14 output of the state of the weapon 16 within the weapon holster 2. The restraining device 3 has a preferable width of less than 4 centimeters to insure compatibility for a variety of weapon holsters by not overlapping and interfering with any weapon retention mechanisms of said holster 2.

With the aforementioned properties of the containing body 1 and its affiliated restraining device 3, the containing body 1 enclosing the microcontroller system 4 can be easily implemented on a variety weapon holsters, without reducing a user's ability to withdrawal a weapon 12 from their holster 2, handle said weapon 16, or access other attached equipment on their persons when using said invention.

The Microcontroller System 4

As shown in FIG. 3 and FIG. 4, the microcontroller system 4 comprises a circuit board 5 on which the microcontroller 6, the memory device 7, the 3.3 volt regulator 8, the 5 volt regulator 9, the power supply 10, the adaptor 11, the radio transmitter 12, and the Hall effect device 13 are attached. The Hall effect device 13 is the only component of the microcontroller system 4 that is strictly defined to a specific position on the circuit board 5 by the preferred embodiment. The leads 22 of the Hall effect sensor 14 of the Hall effect device 13 are attached to the bottom of the front face of the circuit board 5 with the sensor face 23 of the Hall effect sensor 13 protruding over the bottom edge of the circuit board 5 with the sensor face 23 pointed in the same direction as the back face of the circuit board 5. The position of all other components attached to the circuit board 5 may vary with considerations to component shape, component size, signal trace geometry, heat generation, and line impedance.

In the preferred embodiment, the circuit board 5 is a one sided printed circuit board but may also be multi-level printed circuit board. The microcontroller 6 is of a type with the function of a real time clock, in order to output the current time to the memory device 7, and analog input pins, to interpret the voltage level outputted from the Hall effect sensor 14. The memory device 7 is a programmable read-only memory integrated circuit or, in one alternative, an electrically erasable programmable read-only memory integrated circuit. The power supply 10 is a high capacity battery. The adaptor 11 is of a type that enables serial communication to and from the microcontroller 6 and a computer 26, to enable a person to read data stored in the memory device 7. The radio transmitter 12 is a transmitter of a type that sends data through a short range but does not receive data to reduce power consumption from the power supply 10. The Hall effect sensor 14 is of the linear voltage output type.

The Hall effect device 13 comprises a permanent magnet 15 attached to the backside of the Hall effect sensor 14 with the Hall effect sensor face 23 directed toward the weapon receiving pocket 24 of said weapon holster 2 but exterior to said weapon holster 2. The permanent magnet 15 provides the source for a magnetic field that can propagate through solid bodies and that has a magnetic flux density detectable by the Hall effect sensor 14 at the Hall effect sensor face 23. With a weapon 16 not present inside the holster 2, the Hall effect sensor 13 detects a specific magnitude of magnetic flux density, pending on the strength of magnetic field generated by the permanent magnet 15. When a weapon 16 with a weapon slide 25 having ferromagnetic properties is placed in the holster 2 and in front of the Hall effect sensor face 23, the weapon slide 25 interacts with the permanent magnet's 15 magnetic field and induces a greater magnitude of magnetic flux density that is then detected by the Hall effect sensor 14. The outputted voltage from the Hall effect sensor 14 increases with the magnitude of detected magnetic flux density, thus when a weapon 16 with a weapon slide 25 having ferromagnetic properties is placed in the holster 2, the Hall effect sensor 14 outputs a larger voltage than with no weapon 16 present within the weapon holster 2, and therefore the said voltage from the Hall effect sensor 14 is interpretable by the microcontroller 6 to determine the state of the weapon 16 within the weapon holster 2.

With the aforementioned properties of the Hall effect sensor 14 and permanent magnet 15, the Hall effect device 13 does not require mechanical interaction with the weapon receiving pocket 24, any holster retaining mechanism or holster affiliated weapon 16. Therefore, the Hall effect device 13 can be external to the holster 2 and a part of the microcontroller system 4 that is enclosed within the containing body 1. Thus, the Hall effect device 7 facilitates the present invention's aim to not interfere with an authorized user's ability to withdrawal a weapon 16 from their holster 2, handle said weapon 16, or access other attached equipment on their persons and the aim to be easily removed or replaced with limited disturbance to either the holster 2 or weapon 16 to enable user of said devices to maintain full functionality.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An electronic device comprising
(a) a single containing body attachable to a personal weapon holster;
(b) a microcontroller system, enclosed within said single containing body, comprising a Hall effect device, to detect the presence of a weapon within said personal weapon holster, and a microcontroller.

2. The microcontroller system of the electronic device of claim 1 further comprising a memory device.

3. The microcontroller system of the electronic device of claim 1 further comprising a radio transmitter for communication with a video recording device attached to the user of said electronic device.

4. A system for detecting the presence of a weapon within a personal weapon holster comprising:
(a) said weapon having ferromagnetic properties or associated with an item of ferromagnetic properties; and
(b) a Hall effect device, associated with said personal weapon holster but exterior to the weapon receiving pocket of said personal weapon holster, with its sensor face directed towards said weapon receiving pocket of said personal weapon holster whereby the magnitude of magnetic flux detected by said halls effect device differs between the states of said weapon being present within said personal weapon holster and absent from said personal weapon holster.
